(19) United States
(12) Patent Application Publication
(10) Pub. No.: US 2002/0091650 A1
(43) Pub. Date: Jul. 11, 2002

(54) Methods of anonymizing private information

(76) Inventor: Charles V. Ellis, Newton, MA (US)

Correspondence Address: J. PETER FASSE, Fish & Richardson P.C., 225 Franklin Street, Boston, MA, 02110-2804, US

(21) Appl. No.: 09/758,058

(22) Filed: Jan. 9, 2001

(51) Int. Cl. G06F 17/60

(52) U.S. Cl. 705/74

(57) ABSTRACT

The invention is based on new methods to provide marketers, retailers, and others with private and/or confidential consumer data that can provide a clear understanding of their actual customers as a group, or as specific subgroups, including information about their customers' geography, lifestyles, buying habits, demographics, etc., while protecting the privacy and identity of individual consumers.

### TECHNICAL FIELD

This invention relates to methods of using private or confidential consumer data without violating the consumer's privacy.

### BACKGROUND

Consumers have grown increasingly alarmed at the invasion and occasional abuse of their personal privacy, i.e., the use of their name, address, telephone number, and typically numerous other personal facts such as income, birth date, and spouse's name, by marketers. One of the major sources of this invasive behavior by marketers is the common but frequently unauthorized practice of “reverse-identifying” consumers' names and addresses from such identifying sources as credit, debit, ATM, and convenience cards or even telephone numbers. Once a consumer's name and address are known, many commercial data companies are capable of providing more detailed personal information about that consumer.

Typically, a customer enters a store and makes a purchase with his or her credit, debit, convenience, or ATM card. A marketer working on behalf of the store's management collects the summary transaction data and builds a file containing, for instance, credit or debit information, card number, type of item purchased, transaction amount, and date. This is sent to a third party (typically, a major credit reporting agency) who “reverse-identifies” the information, i.e., attaches a name and address to each record in the file by looking up the “owner” of the credit, debit, convenience, or ATM card number. The store thus acquires a list of its customers' names and addresses, and any associated information, such as buying and spending habits, types of purchases made, and timing of purchases, all typically without authorization from the customers. The marketer can further append to this data additional personal facts purchased from other data companies.

There have been many attempts to curtail or ban this activity at both state and federal levels, for obvious reasons. On the other hand, much of the private consumer data that marketers, retailers, and others seek is useful to them, and can ultimately benefit the consumer as well. For example, by knowing their customers' spending and buying habits, retailers can have adequate supplies on hand, gauge the proper prices for specific items, hire the proper number of salespeople, obtain more precisely tailored advertising, determine the number of repeat customers, and determine the effectiveness of their advertising and sales efforts. In addition, with the geographic parts of this information, marketers can create accurate and useful maps of a store's “trade area,” better understand the optimal placement of one store versus another (or competitor), manage the transit challenges their clientele might face, and efficiently plan delivery routes. Beyond geographies, if retailers understand the lifestyle interests of consumers (e.g., how many have cats or dogs, what hobbies are most prevalent in a particular group, and what types of magazines they read) they can, for example, make focused efforts via direct mail or email communications, make smarter advertising decisions, and provide cross-promotions with other product or service providers.

Other categories of information, such as demographics, can be equally useful. For example, knowing that a high proportion of a restaurant's clientele are unmarried, white-collar technology professionals would suggest an emphasis on, e.g., “happy-hour” marketing, trendy menu items, and sophisticated take-out capabilities.

The use of this kind of data and information by retailers can benefit consumers, for example, in the types, varieties, and numbers of items made available for them to purchase, and the price of items. This information can also significantly decrease the number of mail, email, telephone, or other solicitations to individual consumers by enabling marketers to more precisely target only those consumers appropriate for a given offer. Such detailed information also enables retailers to enhance their service(s) to consumers by, for example, offering onsite babysitting where it is known that many of the clientele have very young children, offering free doggy-bags with bones where it is known that many of the clientele have dogs, or noting that menu items in a restaurant are Kosher where it is known that many of the clientele keep Kosher.

### SUMMARY

The invention is based on new methods to provide marketers, retailers, and others with private and/or confidential consumer data that can provide a clear understanding of their actual customers as a group, or as specific subgroups, including information about their customers' geography, lifestyles, buying habits, demographics, etc., while protecting the privacy and identity of individual consumer.

In general, the invention features methods of anonymizing private information about a customer, or a list of customers, by compiling a data file (a paper or electronic file) including transaction information and a Customer Identification Number (e.g., a credit card, debit card, convenience card, bankcard, or telephone number) for one or more specific customers; transferring the data file to a Customer Identifier (e.g., a major credit reporting company) that attaches to the file customer identifying information (e.g., a name, an address, or a name and address) associated with the Customer Identification Number, and removes the Customer Identification Number from the file to generate a modified data file; transferring the modified data file to a Data Vendor (a company that collects consumer data) that adds private information associated with the customer identifying information, to generate an updated data file; and transferring the updated data file to a Trusted Entity (e.g., a well-known consumer advocacy organization such as Common Cause®, or a similar organization focused on privacy in the marketplace, or a credit reporting company) that removes customer identifying information, e.g., name, address, and other geographic information, and any remaining Customer Identification Numbers, to generate an anonymized data file that contains anonymous private information. The Trusted Entity can also randomize, rather than remove, geographic data in the update data file.

These methods can further include transferring the modified data file to a Trusted Entity that reviews the modified data file to remove any remaining customer identification numbers before transferring the modified data file to the Data Vendor.

In another aspect, the invention features systems and software, e.g., stored on a computer-readable medium, for anonymizing private information of a customer. The system includes (a) storage for a data file, e.g., an electronic file that can be encrypted, including a customer identification number associated with a specific customer; (b) storage for a first database including a list of Customer Identification Numbers associated with specific customer identifying information; (c) storage for a second database including private information associated with customer identifying information; and (d) software stored on a computer-readable medium for causing a computer (i) to attach to the data file customer identifying information from the first database associated with the Customer Identification Number and remove from the data file the customer identification number to generate a modified data file; (ii) attach private information to the modified data file from the second database associated with the customer identifying information to generate an updated data file; and (iii) remove from the modified data file customer identifying information and any remaining Customer Identification Numbers to generate an anonymized data file that contains anonymous private information.

In these systems the software can further cause the computer to review the modified data file to remove any Customer Identification Numbers before attaching private information. The software can also cause the computer to remove or randomize geographic data in the update data file, and the data files can further include transaction information. The systems can include an input, e.g., a keyboard or scanner, and/or output device, such as a monitor or printer, to display the anonymized private information. The new systems can be implemented on a computer or on a plurality of computers linked (e.g., via an intranet or the Internet) to enable the transfer of the data files from one computer or database to another.

The invention also features a method for a Trusted Entity to anonymize private information about a customer by obtaining a data file including customer identifying information and transaction information for one or more specific customers (the data file may or may not include Customer Identification Numbers, if it does, these numbers must be removed); transferring the data file to a Data Vendor that adds private information associated with the customer identifying information, to generate an updated data file; and receiving the updated data file from the Data Vendor and removing customer identifying information and any Customer Identification Numbers from the updated data file to generate an anonymized data file that contains anonymous private information.

In another method, a Data Vendor can provide anonymized private information about a customer by obtaining a data file including a list of customer identifying information and transaction information for one or more specific customers, wherein the data file contains no Customer Identification Numbers; attaching to the data file private information associated with the customer identifying information to generate an updated data file; and transferring the updated data file to a Trusted Entity to remove customer identifying information and any remaining Customer Identification Numbers from the updated data file to generate an anonymized data file that contains anonymous private information.

In addition, the invention features a method for a Customer Identifier to provide anonymized private information about a customer by obtaining a data file including transaction information and a Customer Identification Number for a specific customer; attaching to the data file customer identifying information associated with the customer identification number and removing from the data file the customer identification number to generate a modified data file; requesting a Data Vendor to attach private information associated with the customer identifying information, to generate an updated data file, and to transfer the updated data file to a Trusted Entity; and requesting the Trusted Entity to remove customer identifying information and any remaining Customer Identification Numbers from the updated data file to generate an anonymized data file that contains anonymous private information. The method can further include transferring the modified data file to the Trusted Entity to review the modified data file to remove any remaining customer identification numbers before requesting the Trusted Entity to transfer the modified data file to the Data Vendor.

In these methods and systems, the data files (e.g., modified, updated, and/or anonymized data files) can be electronic or paper files and can be encrypted for additional security. The Customer Identification Number can be a credit card, debit card, convenience card, bankcard, and/or telephone number. In addition, the private information added by the Data Vendor can be one or more of age, sex, marital status, parental status, income, education level, race, occupation, ethnicity, property ownership, ages of children, geographic information (such as census and market identifiers), lifestyle preferences (such as hobbies, pet ownership, media watching/listening habits, and magazine and other subscriptions), personal interests (such as travel and fine dining), professional “cluster” definitions (such as Claritas Inc.'s “PRIZM®” identifiers); items purchased; donation habits; and financial information (such as number and types of credit cards owned and investments made).

In addition, all or some of the Customer Identifiers, Trusted Entities, and the Data Vendors can be the same or different companies. For example, the Customer Identifier and Trusted Entity, or Trusted Entity and Data Vendor, or Data Vendor and Customer Identifier, or all three, can be the same company.

A “transaction” is a sale of goods or services. A typical retail transaction record includes a list of all of the items or services that a consumer has purchased, including information specifying any discounts or coupons that were applied, the price of the item, how the sale was paid (“tendered”), the number of the register or workstation at which the transaction was processed, which cashier or server processed the transaction, the name or number of the store in which the transaction occurred, and the date and time of the transaction. A “data file” is a collection of one or more transaction records for one or more different consumers.

Unless otherwise defined, all technical and scientific terms used herein have the same meaning as commonly understood by one of ordinary skill in the art to which this invention belongs. Although methods and equipment or software similar or equivalent to those described herein can be used in the practice of the present invention, suitable methods, equipment, and software are described below. All publications and other references mentioned herein are incorporated by reference in their entirety. In case of conflict, the present specification, including definitions, will control. In addition, the materials, methods, and examples are illustrative only and not intended to be limiting.

The invention provides the clear advantage that important consumer data, which can benefit both marketers/retailers and consumers, can now be obtained by retailers without violating the consumers' privacy. Further, by guaranteeing that consumers' privacy is protected, a dramatically higher percentage of identification types (e.g., credit, convenience, debit, and ATM card numbers, and telephone number) can be successfully reverse-appended to allow the further aggregate analysis of any particular list of such consumer ID's). For example, many credit card issuers such as American Express® will not allow “reverse-appending” of its card numbers because of privacy concerns. The new methods obviate such concerns. Additionally, the detailed “aggregate” data used and generated by the new methods is less expensive to obtain than detailed information about individual consumers, and therefore can save marketers and retailers money.

Other features and advantages of the invention will be apparent from the following detailed description, and from the claims.

### DESCRIPTION OF DRAWINGS

FIG. 1 is a schematic diagram of a method of anonymizing consumer data using a “trusted entity” as an intermediate.

### DETAILED DESCRIPTION

The new methods allow consumers' privacy to be protected while at the same time allowing businesses dealing with those consumers to discover and gain from a detailed knowledge of those consumers' demographics, lifestyles, geography, etc.

General Methodology

The methods rely on the fact that there are established, legally authorized repositories of both consumers' credit, debit, convenience, and ATM card numbers and the matching consumers' names and addresses for each. Examples of such repositories are the major credit reporting companies, such as Equifax®, Experian®, and Trans-Union®. However, other entities hold significant amounts of this data as well. Examples include companies that generate databases of consumers' purchases, credit cards, shipping information, etc.; utilities that do the same; banks of all types; major Internet Service Providers (ISPs) such as America Online® that retain credit card and address information for millions of consumers; and major grocery and other retail chains that maintain “loyalty” databases that also capture similar or identical consumer data. All of these entities face major legal and market obstacles to selling consumer ID's by way of reverse-identifying as described above. However, the methods described herein avoid the need for providing reverse-identifying information to marketers and retailers, while still providing them with useful consumer information stripped of any specific information that would identify individuals, i.e., the new methods provide anonymous detailed consumer information.

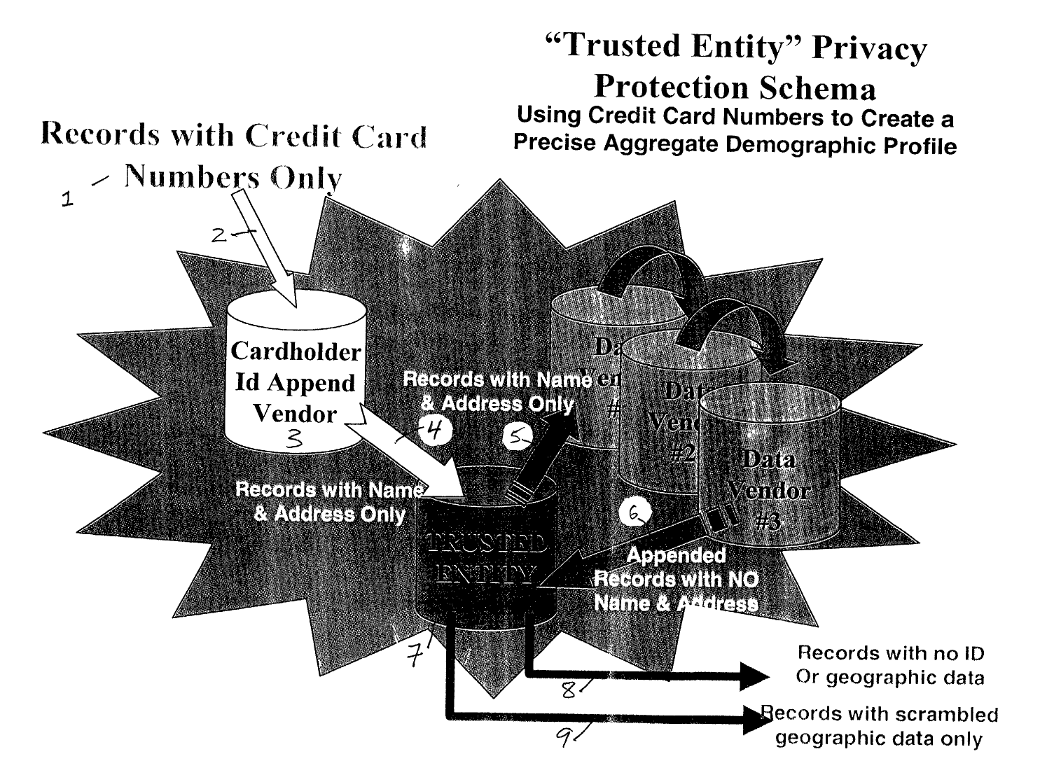

In the new methods, an organization widely acceptable to consumers (“Trusted Entity”) acts as an intermediary between the credit-data entities, additional (name-and-address-based) data appending companies, and the marketers working on behalf of a given store or consumer-centric business. As shown in FIG. 1, the new methods work as follows.

Step 1—A marketer compiles one or more data files, e.g., in a set or list. The set contains one or more data files, each containing the transaction information for an individual consumers' Customer Identification Number, e.g., a credit, debit, convenience, or bank (e.g. automated teller machine (ATM)) card number, or telephone number, but no name or address information for the individual customer is part of these individual files. This set of files contains transaction information. For example in a restaurant, the transaction information includes the date and time the consumer dined at the restaurant, each item that was ordered, the price of the items, how many people were in the party, how the customer paid for the meal, the server or cashier's identity, and many other potentially useful facts about the event. These files can be stored in hard copy on paper, or in electronic form in a database in a computer or on a computer-readable medium, such as a magnetic tape or disk, or in an analog or digital memory. Many typical point-of-sale (POS) systems inherently store all of this data for some period of time. Newer systems collect this same data from many units in a chain and “warehouse” it in a corporate database.

Step 2—The set of files is sent to a “Customer Identifier,” such as a major credit reporting company, e.g., Equifax® (1550 Peachtree Street, Atlanta, Ga. 30309) and TransUnion® (120 South Riverside, 19th Floor, Chicago, Ill. 60606), which holds significant consumer credit data. The set of files can be sent physically to the Customer Identifier, e.g., by mail or courier, or can be sent electronically, e.g., by email, or by other means on a secure intranet, or via the Internet, using appropriate encryption software.

Step 3—The Customer Identifier “reverse-identifies” each Customer Identification Number associated with each file in the list, and appends identifying information, e.g., the consumer's actual name and address, to each file. This manipulation of the files can be done physically, or electronically, e.g., by computer using standard software. For example, “database” software such as Oracle® or SQL Server® or Informix® can be used for such “queries” of the Customer Identifier's database.

Step 4—The Customer Identifier then removes the Customer Identification Number from each file, and transfers the file, e.g., physically or electronically, to a Trusted Entity for verification and further transfer. Such a Trusted Entity might be, for instance, a well-known consumer advocacy organization such as Common Cause®, or a similar organization focused on privacy in the marketplace. The Trusted Entity can also be Equifax®, Experian®, or Trans-Union®. Either the Customer Identifier and Trusted Entity can be the same company (entity), or they can be different. However, consumers might have more confidence in a Trusted Entity that is not also a Customer Identifier, because a non-Customer Identifier Trusted Entity provides an extra set of “impartial eyes” to confirm the removal of the Customer Identification Number and/or address or other identifying information from the data file.

Step 5—Regardless of which organization is chosen, the Trusted Entity examines the set of files, e.g., electronically, to assure that no Customer Identification Numbers are included with any consumer's name and address information, and then transfers the set of files to one or more Data Vendors, such as R. L. Polk (1623 Washington Ave. # 213, Alton, Ill.); Acxiom, Inc. (301 Industrial Blvd., Conway, Ariz.), Claritas, Inc. (San Diego, Calif.), or Geographic Data Technology, Inc. (11 Lafayette St., Lebanon, N.H.). Again, the files can be transferred physically, e.g., by mail or courier, or can be sent electronically, e.g., by email, or by other means on a secure intranet, or via the Internet. These Data Vendors collect and store commercial demographic, geographic, vehicular, lifestyle, and/or other information. In this step 5, the Data Vendors each append the information they have to each data file. The Data Vendor can be the same entity, or a different entity, as the Trusted Entity and as the Consumer Identifier. The same comments made above about consumer confidence apply here as well.

Step 6—Each commercial Data Vendor receives the data file from, appends information to the data file, and returns the updated data file to, the Trusted Entity. Each Data Vendor is adding private information about the particular consumer to each (consumer) record in the data file (but without getting the Customer Identification Number). The private information can be one or more of age, sex, marital status, parental status, income, education level, race, occupation, ethnicity, property ownership, ages of children, geographic information (such as census and market identifiers), lifestyle preferences (such as hobbies, pet ownership, media watching/listening habits, and magazine and other subscriptions), personal interests (such as travel and fine dining), items purchased, donation habits, and financial information (such as number and types of credit cards owned and investments made). The private information can include professional “cluster” data, such as the data generated by Claritas Inc. using its PRIZM® system. Using statistical techniques that employ U.S. census data and consumer data, Claritas Inc. has categorized every community in the U.S. to one of numerous PRIZM clusters. Each PRIZM cluster represents a unique neighborhood type with its own lifestyle and consumer behavior patterns.

After the Data Vendor has appended the particular set of variables contracted for, the data file is returned to the Trusted Entity. Step 6 can be repeated with numerous different Data Vendors, either in parallel or in series, who each add different data to the data file.

Step 7—The Trusted Entity examines each file received back from the various Data Vendors and verifies that there is still no credit, debit, convenience, ATM, or other Customer Identification Number attached to any consumer's record.

When all of the various Data Vendors originally contracted have completed their appending, the Trusted Entity then further process the data file in one or two additional steps.

Step 8—First, all customer-identifying information is removed. This includes name, address, telephone number or any other Customer Identification Number (in the event a number was not removed in the earlier steps) or means by which the customer can be identified.

Step 9—In an optional second step, any potential geographic identifiers, such as latitude and longitude coordinates of the residence, are “cut” out to a separate file, and their record order is scrambled to insure complete privacy. In this way, no “educated guesses” can be made about the customers' identity. Alternatively, any potentially identifiable geographic parameters might be “randomized,” e.g., their values can be altered slightly or the values of a small percentage of the data in a large data set is made significantly incorrect to protect the customer's identity. The U.S. Census Bureau does a similar “randomizing” by taking a small percentage of records, typically less than 5%, and intentionally changing the information to be incorrect. Then the Census Bureau warns any parties who might use the data that such inaccuracies are inherent to the data set. A similar randomization can be used in the data files created in the new methods.

Step 10—Finally, the Trusted Entity delivers the data file(s) back to the marketer, e.g., electronically. At this point, each data file contains a list of records with potentially exhaustive information about the consumers about whom the file was created, but no identities whatsoever, and no address or other identity-related information.

A reasonable fee for handling and processing the file can be paid to the Trusted Entity to cover its costs. Of course, the Consumer Identifier and the Data Vendors are paid for their information, typically for each “batch” of list(s) that are run, and generally factoring in how many thousands of records were processed in each batch.

The marketer may analyze the completed file with any number of analytical techniques. Many well-known software applications can be used in this type of analysis, from standard relational database management systems (RDBMSs) such as Oracle®, IBM's DB2®, and Microsoft's SQL Server®, to more specialized “business intelligence” applications such as Brio®, Business Objects®, Oracle Express®. To those skilled in the art, an extremely accurate and detailed portrait of the “clientele” may then be created, with rich and accurate demographic, geographic, vehicular, lifestyle, psychographic, economic, and/or any other detail. This portrait will also be of sufficient precision to accurately define a list of extremely similar consumers, for the purposes of continued direct marketing efforts.

Implementation

The new methods can be carried out using various means of communication. For example, the individual consumer files can be stored on a computer-readable medium or in a computer memory. The files can be transferred physically on diskettes or electronically, e.g., by email on a dedicated intranet or on the Internet. The files can be encrypted using standard encryption software from such companies as RSA Security (Bedford, Mass.) and Baltimore®.

The files can be stored in various formats, e.g., spreadsheets or database. The files can be manipulated to add additional data and to remove identifying data by commercially available software such as the RDBMS applications named above.

The invention can be implemented in hardware or software, or a combination of both. The invention can be implemented in computer programs using standard programming techniques following the method steps and figures disclosed herein. The programs should be designed to execute on programmable computers each including a processor, a data storage system (including memory and/or storage elements), at least one input device, and at least one output device, such as a CRT or printer. Program code is applied to input data to perform the functions described herein and generate output information. The output information is applied to one or more output devices such as a printer, or a CRT or other monitor.

Each program used in the new methods is preferably implemented in a high level procedural or object oriented programming language to communicate with a computer system. However, the programs can be implemented in assembly or machine language, if desired. In any case, the language can be a compiled or interpreted language.

Each such computer program is preferably stored on a storage medium or device (e.g., ROM or magnetic diskette) readable by a general or special purpose programmable computer, for configuring and operating the computer when the storage media or device is read by the computer to perform the procedures described herein. The system can also be considered to be implemented as a computer-readable storage medium, configured with a computer program, where the storage medium so configured causes a computer to operate in a specific and predefined manner to perform the functions described herein.

Of increasing popularity is the Internet-based processing of such information. In this method, files are transmitted from one processing party to the next in “real time” in encrypted form, with each processing party privy to the decryption technique necessary to process the particular data, ending with the completely processed data being sent back to the marketer over the Internet in a similarly encrypted manner. In this method, the entire process can be performed in minutes.

### EXAMPLE

The following example illustrates how the method works for several consumers buying the same type of item in one store. In most embodiments, many consumer files are collected and manipulated together.

Customers A, B, C, . . . N each buy a cordless telephone in Store X. The transactions are recorded by a point-of-sale (POS) computer. The POS computer generates a data file containing Customer A thru N's credit card numbers, the dates of the transactions, the names of the items (cordless telephone), and the price.

Store X sends the data file to a Customer Identifier (Equifax®), by email. The Customer Identifier adds the customers' names and addresses (Customer A—12 Main Street, Lincoln, Mass.; Customer B—99 Shady Hill Rd., Newton, Mass.; etc.) to the data file and removes the credit card number from the file. Thereafter, it sends the data file to Common Cause® electronically, for file verification and further transfer.

Common Cause examines the data file to assure that no credit card or other identifying number is included with any of the Customers' names or addresses, and then transfers the data file to a Data Vendor (R. L. Polk, Inc.). The Data Vendor uses the Customers' names and addresses to search its computer database, and then locates information specific to each Customer. The Data Vendor retrieves information that Customer A is male, married, has two children ages 8 and 12, has two cars, has a college degree in chemical engineering, and an annual income over $75,000. Customer B is female, unmarried, age 34, owns a new Honda Accord, has no college degree, and an annual income of $50,000. The same type of information is retrieved for each Customer C through N. The Data Vendor appends this information to the data file and returns the file electronically to Common Cause.

Common Cause examines the data file and verifies that there is still no credit, debit, convenience, ATM, or other identification number attached to the file. Then, it strips any remaining customer-identifying information from the file, including names, addresses, and telephone numbers, and any other number or information by which the customers can be individually identified. Next, it also removes any potential geographic identifiers, such as town names and latitude and longitude coordinates of the residence, and moves this information to a separate file.

After all of these data manipulations, Common Cause delivers the anonymized data file back to Store X by email. At this point, the file contains a significant amount of information about all of the Store X's customers who bought a cordless telephone, but without identifying any of those customers.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method of anonymizing private information about a customer, the method comprising
compiling a data file comprising transaction information and a customer identification number for a specific customer;
transferring the data file to a customer identifier that attaches to the file customer identifying information associated with the customer identification number, and removes the customer identification number from the file to generate a modified data file;
transferring the modified data file to a data vendor that adds private information associated with the customer identifying information, to generate an updated data file; and
transferring the updated data file to a trusted entity that removes customer identifying information and any remaining customer identification numbers to generate an anonymized data file that contains anonymous private information.

2. The method of claim 1, further comprising transferring the modified data file to a trusted entity that reviews the modified data file to remove any remaining customer identification numbers before transferring the modified data file to the data vendor.

3. The method of claim 1, wherein removing customer identifying information from the updated data file comprises removing geographic information.

4. The method of claim 1, wherein the customer identification number is a credit card, debit card, convenience card, bankcard, or telephone number.

5. The method of claim 1, wherein the customer identifying information is a name, an address, or a name and address.

6. The method of claim 1, wherein the data file is an electronic file.

7. The method of claim 1, wherein the data file is encrypted.

8. The method of claim 1, wherein the trusted entity randomizes geographic data in the update data file.

9. The method of claim 1, wherein the private information added by the data vendor is one or more of age, sex, marital status, parental status, income, education level, race, occupation, ethnicity, property ownership, ages of children, geographic information, lifestyle preferences, personal interests, cluster definitions, items purchased, donation habits, and financial information.

10. The method of claim 1, wherein the customer identifier and trusted entity are the same company.

11. The method of claim 1, wherein the customer identifier, trusted entity, and data vendor are the same company.

12. The method of claim 1, wherein the trusted entity and data vendor are the same company.

13. A system for anonymizing private information of a customer, the system comprising
storage for a data file comprising a customer identification number associated with a specific customer;
storage for a first database comprising a list of customer identification numbers associated with specific customer identifying information;
storage for a second database comprising private information associated with customer identifying information; and
software stored on a computer-readable medium for causing a computer to
attach to the data file customer identifying information from the first database associated with the customer identification number and remove from the data file the customer identification number to generate a modified data file;
attach private information to the modified data file from the second database associated with the customer identifying information to generate an updated data file; and
remove from the modified data file customer identifying information and any remaining customer identification numbers to generate an anonymized data file that contains anonymous private information.

14. The system of claim 13, wherein the software further causes a computer to review the modified data file to remove any customer identification numbers before attaching private information.

15. The system of claim 13, further comprising an output device to display the anonymized private information.

16. The system of claim 13, wherein the system is implemented on a computer or on a plurality of computers linked to enable the transfer of the data file from one computer to another.

17. The system of claim 13, wherein the customer identification number is a credit card, debit card, convenience card, bankcard, or telephone number.

18. The system of claim 13, wherein the customer identifying information is a name, address, or name and address.

19. The system of claim 13, wherein the data file is an electronic file.

20. The system of claim 13, wherein the data file is encrypted.

21. The system of claim 13, wherein the software causes the computer to randomize geographic data in the update data file.

22. The system of claim 13, wherein the private information attached to the modified data file is one or more of age, sex, marital status, parental status, income, education level, race, occupation, ethnicity, property ownership, ages of children, geographic information, lifestyle preferences, personal interests, cluster definitions, items purchased, donation habits, and financial information.

23. The system of claim 13, wherein the data file further comprises transaction information.

24. A method for a trusted entity to anonymize private information about a customer, the method comprising
obtaining a data file comprising customer identifying information and transaction information for one or more specific customers;
transferring the data file to a data vendor that adds private information associated with the customer identifying information, to generate an updated data file; and
receiving the updated data file from the data vendor and removing customer identifying information and any customer identification numbers from the updated data file to generate an anonymized data file that contains anonymous private information.

25. The method of claim 24, further comprising removing from the data file any customer identification numbers before transferring the data file to the data vendor.

26. The method of claim 24, wherein the trusted entity and data vendor are the same company.

27. The method of claim 25, wherein the customer identification number is a credit card, debit card, convenience card, bankcard, or telephone number.

28. The method of claim 24, wherein the customer identifying information is a name, an address, or a name and address.

29. The method of claim 24, wherein the data file is an electronic file.

30. The method of claim 24, wherein the data file is encrypted.

31. The method of claim 24, wherein the trusted entity randomizes geographic data in the update data file.

32. The method of claim 24, wherein the private information added by the data vendor is one or more of age, sex, marital status, parental status, income, education level, race, occupation, ethnicity, property ownership, ages of children, geographic information, lifestyle preferences, personal interests, cluster definitions, items purchased, donation habits, and financial information.

33. A method for a data vendor to provide anonymized private information about a customer, the method comprising
obtaining a data file comprising a list of customer identifying information and transaction information for one or more specific customers, wherein the data file contains no customer identification numbers;
attaching to the data file private information associated with the customer identifying information to generate an updated data file; and
transferring the updated data file to a trusted entity to remove customer identifying information and any remaining customer identification numbers from the updated data file to generate an anonymized data file that contains anonymous private information.

34. The method of claim 33, wherein the trusted entity and data vendor are the same company.

35. The method of claim 33, wherein the customer identification number is a credit card, debit card, convenience card, bankcard, or telephone number.

36. The method of claim 33, wherein the customer identifying information is a name, an address, or a name and address.

37. The method of claim 33, wherein the data file is an electronic file.

38. The method of claim 33, wherein the data file is encrypted.

39. The method of claim 33, wherein the private information is one or more of age, sex, marital status, parental status, income, education level, race, occupation, ethnicity, property ownership, ages of children, geographic information, lifestyle preferences, personal interests, cluster definitions, items purchased, donation habits, and financial information.

40. A method for a customer identifier to provide anonymized private information about a customer, the method comprising
obtaining a data file comprising transaction information and a customer identification number for a specific customer;
attaching to the data file customer identifying information associated with the customer identification number and removing from the data file the customer identification number to generate a modified data file;
requesting a data vendor to attach private information associated with the customer identifying information, to generate an updated data file, and to transfer the updated data file to a trusted entity; and
requesting the trusted entity to remove customer identifying information and any remaining customer identification numbers from the updated data file to generate an anonymized data file that contains anonymous private information.

41. The method of claim 40, further comprising transferring the modified data file to the trusted entity to review the modified data file to remove any remaining customer identification numbers before requesting the trusted entity to transfer the modified data file to the data vendor.

42. The method of claim 40, wherein the customer identifier, trusted entity, and data vendor are the same entity.

43. The method of claim 40, wherein the customer identifier and trusted entity are the same entity.

44. The method of claim 40, wherein the customer identifier and data vendor are the same entity.

45. The method of claim 40, wherein the customer identification number is a credit card, debit card, convenience card, bankcard, or telephone number.

46. The method of claim 40, wherein the customer identifying information is a name, an address, or a name and address.

47. The method of claim 40, wherein the data file is an electronic file.

48. The method of claim 40, wherein the data file is encrypted.

49. The method of claim 40, wherein the trusted entity randomizes geographic data in the update data file.

50. The method of claim 40, wherein the private information added by the data vendor is one or more of age, sex, marital status, parental status, income, education level, race, occupation, ethnicity, property ownership, ages of children, geographic information, lifestyle preferences, personal interests, cluster definitions, items purchased, donation habits, and financial information.
